(19) United States
(12) Patent Application Publication
(10) Pub. No.: US 2010/0302441 A1
(43) Pub. Date: Dec. 2, 2010

(54) INFORMATION PROCESSING APPARATUS, INFORMATION PROCESSING METHOD, AND PROGRAM

(75) Inventor: Nobuyuki Yuasa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/788,135

(22) Filed: May 26, 2010

(30) Foreign Application Priority Data
Jun. 2, 2009 (JP) 2009-133381

(51) Int. Cl. H04N 9/475

(52) U.S. Cl. 348/515; 348/E09.034

(57) ABSTRACT

An information processing apparatus according to the present invention includes: a transformation unit configured to perform an image data transformation processing to transform a shape of image data; a first determination unit configured to determine an output position of audio data in association with the image data based on transformation information regarding the image data transformation processing performed by the transformation unit; and a configuration unit configured to construct a sound field based on the output position determined by the first determination unit.

### BACKGROUND OF THE INVENTION

1. Field of the Invention

The present invention relates to a technique for outputting audio in association with the shape and layout position of image data.

2. Description of the Related Art

A known technique for configuring a sound field corresponding to an on-screen image or video frame (window) adjusts the sound volume and balance of a target image coming from left and right speakers according to the two-dimensional position of the on-screen image (for example, refer to Japanese Patent Application Laid-Open No. 2007-81675).

Another known technique for configuring a sound field determines the direction from which audio is coming according to the two-dimensional position of an on-screen image and the position of a viewer (for example, refer to Japanese Patent Application Laid-Open No. 11-126153).

However, with respect to the conventional technique for adjusting the sound volume and balance of the target image coming from the left and right speakers, there has been a problem that distinguishing among a plurality of audios is difficult because of poor directivity.

There has been another problem that location of the viewer's position is necessary to configure a sound field in which the viewer can hear audio right from the direction of a target image.

### SUMMARY OF THE INVENTION

The present invention is directed to presenting a favorable and easily distinguishable audio in association with the shape and layout position of image data, without performing complicated adjustment.

An information processing apparatus according to the present invention includes: a transformation unit configured to perform an image data transformation processing to transform a shape of image data; a first determination unit configured to determine an output position of audio data in association with the image data based on transformation information regarding the image data transformation processing performed by the transformation unit; and a configuration unit configured to construct a sound field based on the output position determined by the first determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a video/audio output apparatus according to a first exemplary embodiment of the present invention.

FIG. 2 is a flow chart illustrating processing performed by the video/audio output apparatus according to the first exemplary embodiment of the present invention.

FIG. 3 illustrates a configuration of a video/audio output apparatus according to a second exemplary embodiment of the present invention.

FIG. 4 is a flow chart illustrating processing performed by the video/audio output apparatus according to the second exemplary embodiment of the present invention.

FIG. 5 illustrates a configuration of a video/audio output apparatus according to a third exemplary embodiment of the present invention.

FIG. 6 illustrates a configuration of a video/audio output apparatus according to a fourth exemplary embodiment of the present invention.

FIG. 7 is a flow chart illustrating processing performed by the video/audio output apparatus according to the fourth exemplary embodiment of the present invention.

FIG. 8 illustrates an image or video output through the processing by the first exemplary embodiment of the present invention, and a position of audio output in association with the image or video.

FIG. 9 illustrates images or videos output through the processing according to the third exemplary embodiment of the present invention, and positions of audios output in association with the images or videos.

FIG. 10 illustrates images or videos output through the processing according to the fourth exemplary embodiment of the present invention, and positions of audios output in association with the images or videos.

### DESCRIPTION OF THE EMBODIMENTS

Various exemplary embodiments, features, and aspects of the invention will be described in detail below with reference to the drawings.

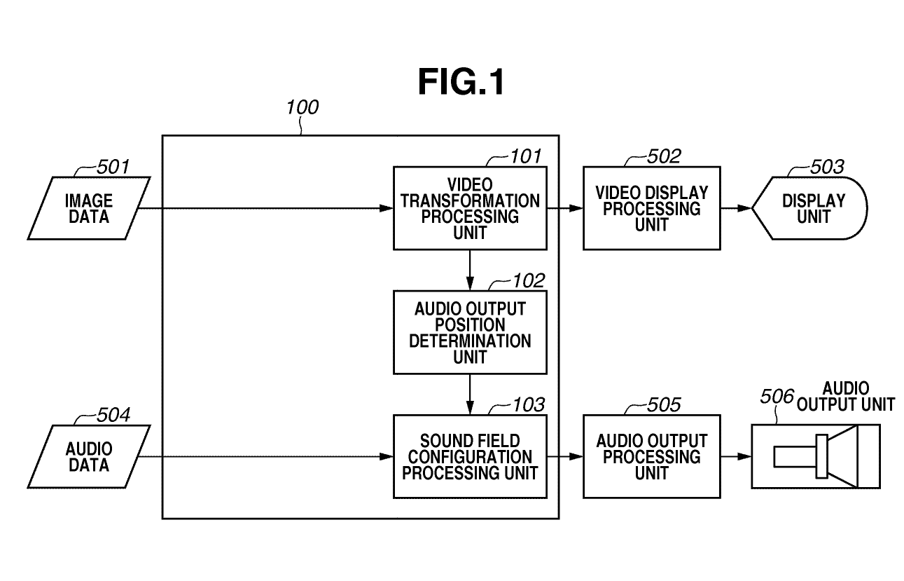

A first exemplary embodiment of the present invention will be described below. FIG. 1 illustrates a configuration of a video/audio output apparatus according to the first exemplary embodiment of the present invention.

Referring to FIG. 1, a video/audio output apparatus 100 according to the present exemplary embodiment includes a video transformation processing unit 101, an audio output position determination processing unit 102, and a sound field configuration processing unit 103. The video/audio output apparatus 100 inputs image data (or video data) 501 and audio data 504. The video/audio output apparatus 100 is an application example of an information processing apparatus of the present invention. The image data 501 is an application example of image data in the present invention.

A video transformation processing unit 101 transforms the two-dimensional shape of the image data 501 and then outputs the transformed image data to a video display processing unit 502. The video transformation processing unit 101 is an application example of a transformation unit described in claim 1.

The audio output position determination processing unit 102 determines an output position of the audio data 504 by utilizing transformation processing information output from the video transformation processing unit 101. The audio output position determination processing unit 102 is an application example of a first determination unit described in claim 1.

A sound field configuration processing unit 103 configures a sound field in which the audio data 504 is to be output, based on the positional information determined by the audio output position determination processing unit 102. The sound field configuration processing unit 103 is an application of the configuration unit described in claim 1.

The video display processing unit 502 inputs the image data transformed by the video transformation processing unit 101, performs conversion processing to enable displaying the image data on a display unit 503, and outputs the converted image data to the display unit 503.

An audio output processing unit 505 inputs the audio data 504 generated by the sound field configuration processing unit 103, performs conversion processing to enable outputting the audio data to an audio output unit 506 such as speakers, and outputs the converted audio data to the audio output unit 506.

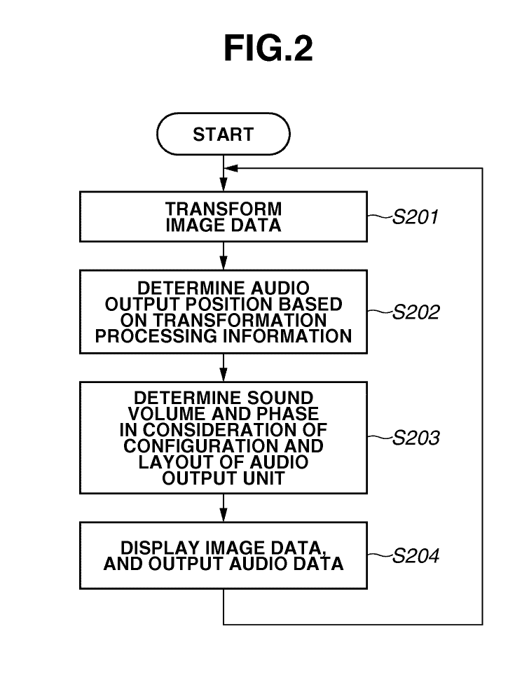

Processing performed by the video/audio output apparatus 100 according to the first exemplary embodiment of the present invention will be described below. FIG. 2 is a flow chart illustrating the processing performed by the video/audio output apparatus according to the present exemplary embodiment.

The video transformation processing unit 101 inputs the image data 501. In step 5201, the video transformation processing unit 101 performs conversion processing for transforming the two-dimensional shape of the image data 501. The two-dimensional transformation processing of image data refers to enlargement, reduction, rotation, trapezoidal transformation, and quadrangular transformation. For example, the trapezoidal transformation processing includes adding an expansion count to each input pixel or multiplying each input pixel by the expansion count to perform coordinates conversion (for example, refer to Japanese Patent Application Laid-Open No. 2007-166009).

The video transformation processing unit 101 outputs to the audio output position determination processing unit 102 the transformation processing information representing transformation processing parameters used or obtained by the video transformation processing unit 101 at the time of the transformation processing. The transformation processing parameters include the expansion count and the length of each trapezoid side after conversion, for example, in the case of trapezoidal transformation processing. In step S202, the audio output position determination processing unit 102 determines one-, two-, or three-dimensional position for audio output based on the transformation processing information.

For example, in the case of transformation from a rectangular to a trapezoid, the audio output position determination processing unit 102 calculates a one-dimensional position for audio output according to the ratio of the length of the left-hand side, lL, to the length of the right-hand side, lR, of the trapezoid after conversion. The one-dimensional output position AP1(x) can be represented by the following formula:

AP1(x)=x0+C*(1L/1R)

where x0 denotes a reference position and C denotes an output position change factor.

The sound field configuration processing unit 103 inputs the audio output positional information representing the audio output position obtained as above as well as the audio data 504. In step S203, the sound field configuration processing unit 103 determines the sound volume and phase for each component of the audio output unit 506 in consideration of the configuration and layout of the audio output unit 506.

The video display processing unit 502 inputs the image data transformed by the video transformation processing unit 101. The video display processing unit 502 performs processing to enable displaying the input image data on the display unit 503. The video display processing unit 502 outputs the processed image data to the display unit 503. In step S204, the display unit 503 displays the image data input from the video display processing unit 502. Also in step S204, the audio output processing unit 505 inputs the sound volume and phase determined as above as well as the audio data 504, performs conversion processing to enable outputting the audio data 504 to the audio output unit 506, and outputs the converted audio data to the audio output unit 506.

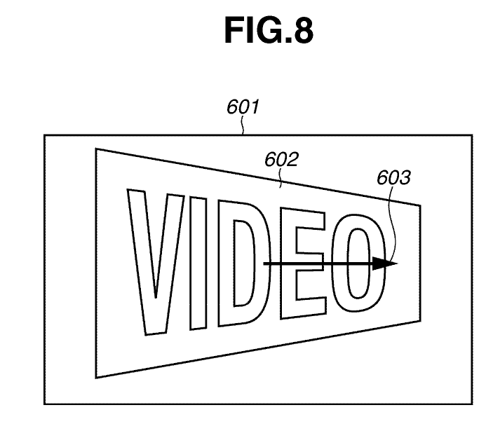

FIG. 8 illustrates a video or image output through the above-mentioned processing, and a position of audio output in association with the video or image. A display area 601 on the display unit 503 displays an image frame 602 and an arrow 603. The top of the arrowhead of the arrow 603 indicates the audio output position.

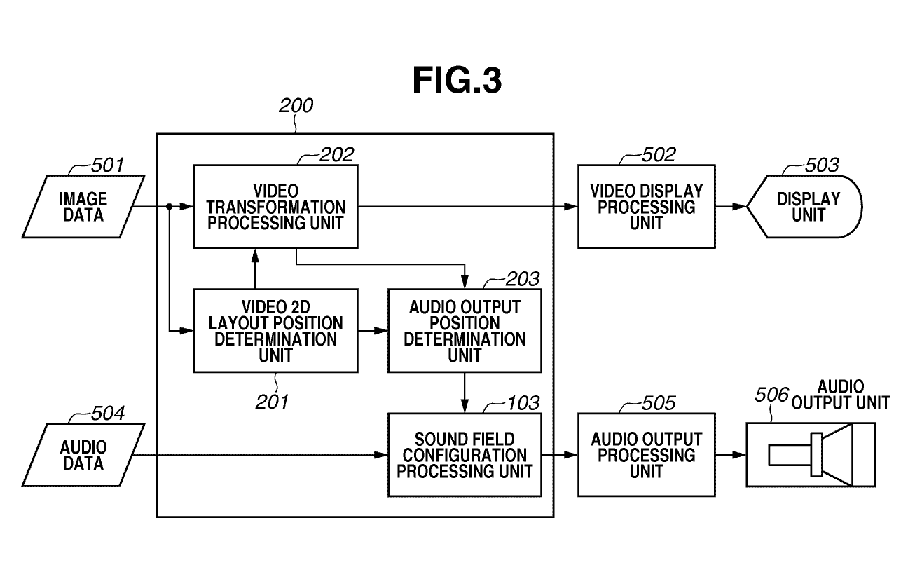

A second exemplary embodiment of the present invention will be described below. FIG. 3 illustrates a configuration of a video/audio output apparatus according to the second exemplary embodiment of the present invention.

Referring to FIG. 3, a video/audio output apparatus 200 according to the present exemplary embodiment includes a video 2D layout position determination processing unit 201, a video transformation processing unit 202, an audio output position determination processing unit 203, and a sound field configuration processing unit 103. The video 2D layout position determination processing unit 201 determines where the input image data 501 is to be arranged in the two-dimensional area including the display area 601 of the display unit 503 finally displayed and then arranges the image data at the determined position. The video 2D layout position determination processing unit 201 is an application example of the second determination unit described in claim 2.

The video transformation processing unit 202 transforms the two-dimensional shape of the input image data and then outputs the transformed image data to a video display processing unit 502.

The audio output position determination processing unit 203 determines an output position of the audio data 504 by using two-dimensional layout information output from the video 2D layout position determination processing unit 201, and transformation processing information output from the video transformation processing unit 202. The sound field configuration processing unit 103 has a similar configuration to that of the sound field configuration processing unit 103 in FIG. 1. The two-dimensional layout information represents where the image data 501 has been arranged in the two-dimensional area.

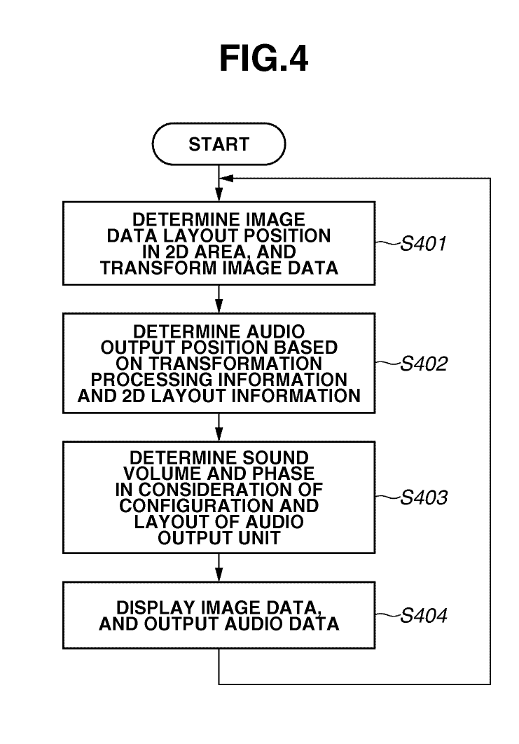

Processing performed by the video/audio output apparatus 200 according to the second exemplary embodiment of the present invention will be described below. FIG. 4 is a flow chart illustrating processing performed by the video/audio output apparatus 200 according to the present exemplary embodiment.

The video 2D layout position determination processing unit 201 inputs the image data 501. In step S401, the video 2D layout position determination processing unit 201 determines where the input image data 501 is to be arranged in the two-dimensional area by using preset values. The video transformation processing unit 202 also inputs the image data 501. In step S401, the video transformation processing unit 202 performs conversion processing for transforming the two-dimensional shape of the image data 501 by using the two-dimensional layout information determined by the video 2D layout position determination processing unit 201 as well as preset transformation processing parameters.

The video transformation processing unit 202 outputs to the audio output position determination processing unit 203 the transformation processing information representing transformation processing parameters used or obtained by the video transformation processing unit 202 at the time of the transformation processing, and the two-dimensional layout information obtained by the video 2D layout position determination processing unit 201. The transformation processing parameters include the expansion count and the length of each trapezoid side after conversion, for example, in the case of trapezoidal transformation processing, In step S402, the audio output position determination processing unit 203 determines one-, two-, or three-dimensional position for audio output based on the transformation processing information and two-dimensional layout information.

For example, in the case of transformation from a rectangular to a trapezoid, the audio output position determination processing unit 203 calculates a two-dimensional position for audio output according to the ratio of the length of the top side, lT, to the length of the bottom side, lB, and the ratio of the length of the left-hand side, lL, to the length of the right-hand side, lR, of the trapezoid after conversion. A two-dimensional output position AP(x, y) in the orthogonal coordinate system (x, y) can be represented by the following formula:

AP(x,y)=(x+Cx+(1L/1R),y+Cy*(1T/1B))

where Cx and Cy denote output position change counts in the x-axis and y-axis directions, respectively.

The sound field configuration processing unit 103 inputs the audio output positional information obtained as above as well as the audio data 504. In step S403, the sound field configuration processing unit 103 determines the sound volume and phase for each component of the audio output unit 506 in consideration of the configuration and layout of the audio output unit 506.

The video display processing unit 502 inputs the image data transformed by the video transformation processing unit 202. The video display processing unit 502 performs processing to enable displaying the input image data on the display unit 503. The video display processing unit 502 outputs the processed image data to the display unit 503. In step S404, the display unit 503 displays the image data input from the video display processing unit 502. Also in step S404, the audio output processing unit 505 inputs the sound volume and phase determined as above as well as the audio data 504, performs conversion processing to enable outputting the audio data 504 to the audio output unit 506, and outputs the converted audio data to the audio output unit 506.

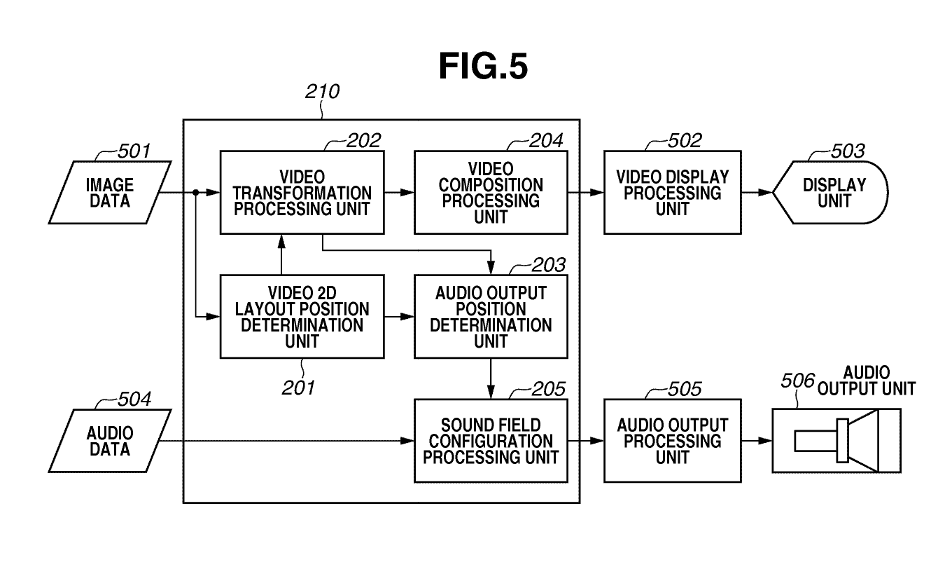

A third exemplary embodiment of the present invention will be described below. FIG. 5 illustrates a configuration of a video/audio output apparatus according to the third exemplary embodiment of the present invention.

The configuration in FIG. 5 differs from the configuration in FIG. 3 in that a video composition processing unit 204 is inserted between the video transformation processing unit 202 and the video display processing unit 502, and the sound field configuration processing unit 103 is replaced by the sound field configuration processing unit 205 which processes a plurality of pieces of input audio data. The video composition processing unit 204 is an application example of the composition unit described in claim 2.

The video composition processing unit 204 combines the results of processing for a plurality of input image frames, enabling simultaneously displaying or presenting the plurality of image frames and audios.

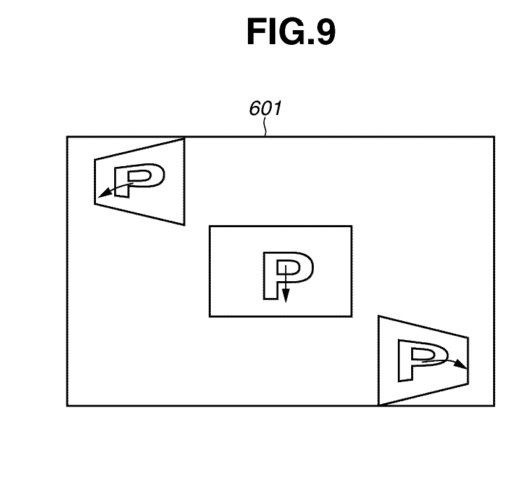

FIG. 9 illustrates images output through the above-mentioned processing, and positions of audios output in association with the images. In this example, three different image frames are simultaneously displayed and an audio output position is determined for each frame, thus configuring a sound field.

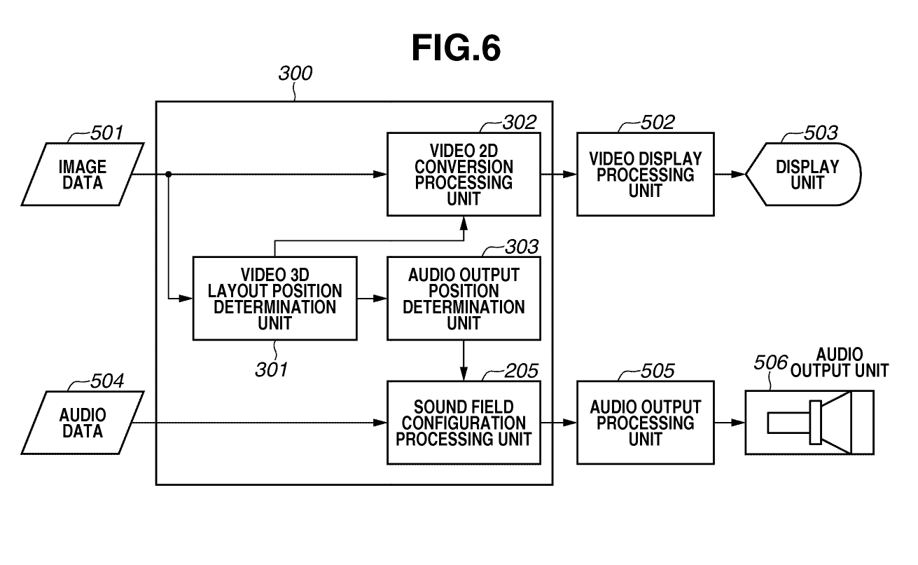

A fourth exemplary embodiment of the present invention will be described below. FIG. 6 illustrates a configuration of a video/audio output apparatus according to the fourth exemplary embodiment of the present invention.

Referring to FIG. 6, a video/audio output apparatus 300 according to the present exemplary embodiment includes a video 3D layout position determination processing unit 301, a video 2D conversion processing unit 302, an audio output position determination processing unit 303, and a sound field configuration processing unit 205. The video 3D layout position determination processing unit 301 determines where the input image data 501 is to be arranged in a virtual 3D area and then arranges the image data at the determined position. The video 3D layout position determination processing unit 301 is an application example of the first determination unit described in claim 4.

The video 2D conversion processing unit 302 converts the three-dimensionally arranged image data 501 into two-dimensional image data to enable two-dimensional display. The video 2D conversion processing unit 302 is an application example of the conversion unit described in claim 5.

The audio output position determination processing unit 303 determines an output position of the audio data 504 by using three-dimensional layout information determined by the video 3D layout position determination processing unit 301. The three-dimensional layout information represents where the image data 501 has been arranged in a virtual three-dimensional area. The audio output position determination processing unit 303 is an application example of the second determination unit described in claim 4. The sound field configuration unit 205 in FIG. 6 is an application example of the configuration unit described in claim 4.

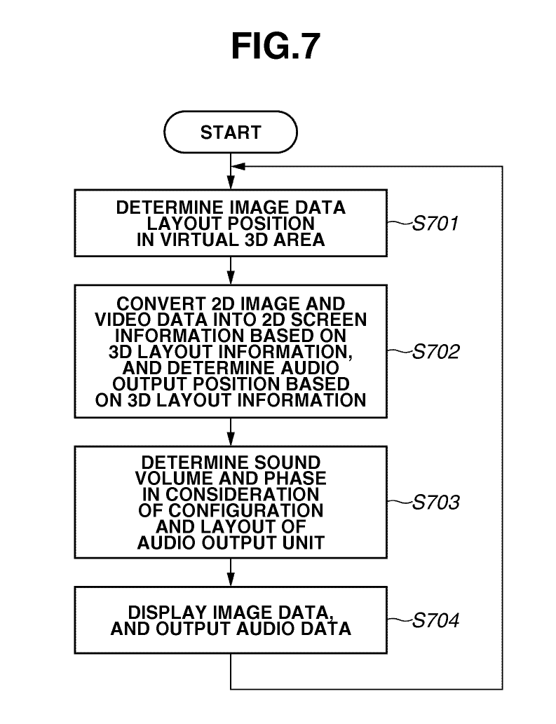

Processing performed by the video/audio output apparatus 300 according to the fourth exemplary embodiment of the present invention will be described below. FIG. 7 is a flow chart illustrating the processing performed by the video/audio output apparatus 300 according to the present exemplary embodiment.

The video 3D layout position determination processing unit 301 inputs one or a plurality of pieces of image data 501. In step S701, the video 3D layout position determination processing unit 301 determines where the input image data 501 is to be arranged in the virtual three-dimensional area.

The video 2D conversion processing unit 302 also inputs one or a plurality of pieces of image data 501. In step S702, the video 2D conversion processing unit 302 performs map conversion of the input image data 501 to two-dimensional screen information based on the three-dimensional layout information determined by the video 3D layout position determination processing unit 301. Also in step S702, the audio output position determination processing unit 303 inputs the one or the plurality of pieces of three-dimensional layout information determined by the video 3D layout position determination processing unit 301. In step S702, the audio output position determination processing unit 303 determines one-, two-, or three-dimensional position for audio output based on the input three-dimensional layout information. For example, the audio output position determination processing unit 303 arranges image data of a rectangular in a virtual three-dimensional space, and determines that audio is to be vertically output from the gravity point of the rectangular. In the virtual three-dimensional space, the output position can be obtained with the following procedures. In the orthogonal coordinate system (x, y, z), four apexes of the rectangular are represented as p0(x0, y0, z0), p1(x1, y1, z1), p2(x2, y2, z2), and p3(x3, y3, z3) in the clockwise direction. In this case, the gravity point g of the image data of the rectangular is represented by the following formula:

g(x,y,z)=((x0+x2)/2,(y0+y2)/2,(z0+z2)/2)

When the distance from a plane at the audio output position is h(xh,yh,zh), an audio output position AP is represented by the following formula:

AP(x,y,z)=g+h=((x0+x2)/2+xh,(y0+y2)/2+yh,(z0+z2)/2+zh)

The sound field configuration processing unit 205 inputs the one or the plurality of pieces of audio output positional information obtained as above as well as the audio data 504. In step S703, the sound field configuration processing unit 205 determines the sound volume and phase for each component of the audio output unit 506 in consideration of the configuration and layout of the audio output unit 506.

The video display processing unit 502 inputs the image data converted by the video 2D conversion processing unit 302. The video display processing unit 502 performs processing to enable displaying the input image data on the display unit 503. The video display processing unit 502 outputs the processed image data to the display unit 503. In step S704, the display unit 503 displays the image data input from the video display processing unit 502. Also in step S704, the audio output processing unit 505 inputs the sound volume and phase determined as above as well as the audio data 504, performs conversion processing to enable outputting the audio data 504 to the audio output unit 506, and outputs the converted audio data to the audio output unit 506.

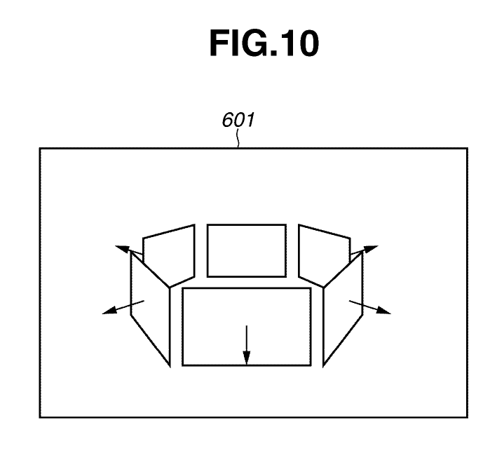

FIG. 10 illustrates images output through the above-mentioned processing, and positions of audios output in association with the images. In this example, six different image frames are simultaneously displayed and an audio output position is determined for each frame, thus configuring a sound field.

Although the present exemplary embodiment vertically outputs audio, when an image or video is moving, the angle of audio output direction may be adjusted to the motion.

In the above-mentioned the exemplary embodiments, the output position of associated audio data is determined based on the transformation information regarding the transformation processing and layout position of image data to configure a sound field. This enables presenting favorable and easily distinguishable audios in association with the shape and layout position of image data, without performing complicated adjustment.

Specifically, in the above-mentioned exemplary embodiments, configuring a sound field having a high directivity in association with the shape and layout position of image data makes possible the presentation of audios not restricted by the viewer's position. This technique makes it easier to distinguish among a plurality of audios simultaneously output.

Further, the direction of audio output matches the shape and layout position of image data, making it easier to associate images or videos with audios more intuitively.

Each unit and each step constituting the above-mentioned exemplary embodiments of the present invention can be attained by executing a program stored in a random access memory (RAM) and a read-only memory (ROM) in a computer. The program and a computer-readable recording medium storing the program are also included in the present invention.

The present invention can be embodied, for example, as a system, an apparatus, a method, a program, or a recording medium. Specifically, the present invention may be applied to an apparatus composed of one device.

The present invention directly or remotely supplies a software program for attaining the functions of the above-mentioned exemplary embodiments to a system or apparatus. The present invention includes a case where a computer of the system or apparatus loads and executes the supplied program code to attain the relevant functions.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-133381 filed Jun. 2, 2009, which is hereby incorporated by reference herein in its entirety.

What is claimed is:

1. An information processing apparatus, comprising:
a transformation unit configured to perform an image data transformation processing to transform a shape of image data;
a first determination unit configured to determine an output position of audio data in association with the image data based on transformation information regarding the image data transformation processing performed by the transformation unit; and
a configuration unit configured to construct a sound field based on the output position determined by the first determination unit.

2. The information processing apparatus according to claim 1, further comprising:
a second determination unit configured to determine a layout position of the image data in a two-dimensional area,
wherein the first determination unit further is configured to determine an output position of the audio data based on two-dimensional layout information, wherein the two-dimensional layout information represents the layout position determined by the second determination unit.

3. The information processing apparatus according to claim 1, further comprising:
a composition unit configured to combine a plurality of pieces of image data,
wherein the first determination unit is configured to determine output positions of a plurality of pieces of audio data in association with the plurality of pieces of image data.

4. An information processing apparatus, comprising:
a first determination unit configured to determine a layout position of image data in a virtual three-dimensional area;
a second determination unit configured to determine an output position of audio data in association with the image data based on three-dimensional layout information, wherein the three-dimensional layout information represents the layout position determined by the first determination unit; and
a configuration unit configured to construct a sound field based on the output position determined by the second determination unit.

5. The information processing apparatus according to claim 4, further comprising:
a conversion unit configured to convert the image data into two-dimensional image data based on the three-dimensional layout information.

6. A method for processing information, the method comprising:
transforming a shape of image data using image data transformation processing;
determining an output position of audio data in association with the image data based on transformation information regarding the image data transformation processing; and
configuring a sound field based on the determined output position.

7. A method for processing information, the method comprising:
first determining a layout position of image data in a virtual three-dimensional area;
second determining an output position of audio data in association with the image data based on three-dimensional layout information representing the layout position determined by the first determining; and
configuring a sound field based on the output position determined by the second determining.

8. A computer-readable medium having stored thereon, a program for causing an information processing apparatus to perform a method, the method comprising:
transforming a shape of image data using image data transformation processing;
determining an output position of audio data in association with the image data based on transformation information regarding the image data transformation processing; and
configuring a sound field based on the determined output position.

9. A computer-readable medium having stored thereon, a program for causing an information processing apparatus to perform a method, the method comprising:
first determining a layout position of image data in a virtual three-dimensional area;
second determining an output position of audio data in association with the image data based on three-dimensional layout information representing the layout position determined by the first determining; and
configuring a sound field based on the output position determined by the second determining.
